(19) United States
(12) Patent Application Publication
(10) Pub. No.: US 2025/0011044 A1
(43) Pub. Date: Jan. 9, 2025

(54) TUBE-TYPE LIQUID DISCHARGING CONTAINER

(71) Applicant: PUM-TECH KOREA CO., LTD, Incheon (KR)

(72) Inventor: Do Hoon LEE, Incheon (KR)

(21) Appl. No.: 18/712,221

(22) PCT Filed: Nov. 11, 2022
(86) PCT No.: PCT/KR2022/017696

§ 371 Date: May 21, 2024

(30) Foreign Application Priority Data
Dec. 24, 2021 (KR) 10-2021-0186818

(51) Int. Cl. B65D 35/46; B65D 35/38

(52) U.S. Cl. CPC B65D 35/46; B65D 35/38

(57) ABSTRACT

A tube-type liquid discharging container according to an embodiment of the present invention comprises: a tube body having contents stored therein and having an inlet part; a shoulder coupled to the inlet part of the tube body and having a discharge port; an inner housing formed inside the shoulder and having a contents inlet hole formed on one side thereof; an opening and closing rod formed on the inner housing to open and close the discharge port by reciprocating; an elastic member elastically supporting the opening and closing rod; an outer housing coupled to the inner housing by surrounding the outer side of the inner housing, and having a contents outlet; and a valve installed on the contents outlet of the outer housing to open and close the contents outlet, wherein the inner housing and the outer housing are located a fixed distance away from each other, and a flow channel for contents is formed therebetween.

### TECHNICAL FIELD

One aspect of the present disclosure relates to a tube-type liquid discharging container, and more particularly, to a tube-type liquid discharging container in which a flow channel for contents is ensured through a double housing structure, and an opening and closing structure is formed on each of a tube body and a shoulder, so that a smooth discharge operation, stable sealing, and hygienic use are enabled.

### BACKGROUND ART

Today, in modern society, according to the current of rapidly diversifying times, people of all ages and genders are using cosmetics according to their needs. In particular, women use various types of cosmetics, cosmetic products with various colors, tools, and the like, and various high-quality cosmetic products and tools are being released into the market every day through research and development of cosmetics-related companies.

When the cosmetics are classified according to their purpose of use, the cosmetics may be classified into facial cleansing cosmetics used to remove sebum, waste, and pollutants from a skin surface, basic cosmetics used to properly supply moisture and oil to the skin, color cosmetics used to express beautiful colors, hair cosmetics used to remove foreign substances from hair or scalp while protecting the hair and supplying nutrition to the hair, perfumes obtained by dissolving fragrances in alcohol and used to exude a scent to others, and the like.

Meanwhile, the cosmetics are frequently manufactured from natural raw materials as interest in safety of compositions of the cosmetics and skin beauty are increased due to the improvement of living standards. However, since preservatives and the like are not added to such cosmetics in order to minimize irritation to the skin, the cosmetics have a relatively high risk of deterioration as compared with cosmetics manufactured from chemical raw materials. For example, upon use, the cosmetics may be infiltrated by bacteria due to contact with external air, or the compositions of the cosmetics may be oxidized due to the contact with the air, so that contamination or deterioration of the cosmetics may be caused.

In addition, containers having a simple opening and closing function have been used to store and use cosmetics in liquid or gel forms, such as lotions, creams, gels, shampoos, and rinses, among the cosmetics. However, there was an inconvenience that the cosmetics have to be taken out from the container with a spatula or a finger and applied to the skin or hair for use.

Accordingly, tube containers that discharge cosmetics to an outside through a change in an internal pressure, which is caused by pressing of the containers, are being used.

The tube container has a structure in which the cosmetics accommodated in the container are discharged to the outside through a discharge port of a nozzle as a user presses a soft container inward to change the internal pressure of the container, and includes a tube body configured to contain and store a gel material having highly viscosity in the tube body and formed of a soft material, a shoulder coupled to an upper portion of the tube body and having a discharge port, and a tube lid configured to open and close the discharge port.

However, according to the tube container of the related art, the discharge port is opened when the tube lid is opened, so that external air or foreign substances may be introduced through the discharge port, which causes contamination or deterioration of contents accommodated in the tube container. In addition, even when an external force that pressed the tube container is removed, the contents may be continuously discharged by the internal pressure of the tube container, so that it may be difficult to control a discharge amount, which results in waste of the contents and insanitariness.

To solve such problems, Korean Utility Model Registration No. 20-0400310 has disclosed a valve device for a tube-type cosmetic container. According to the related art, a support body is coupled and installed to circumferentially form a discharge hole and a discharge gap at an inner center of a valve body, an insertion groove is formed at an upper center of the support body, and an elastic spring and a piston configured to receive elasticity by the elastic spring are inserted into the insertion groove, so that the piston is elastically pressed along with a pressure that presses a main body of a tube container to open and close a valve hole of the valve body.

However, the related art has a structure in which contents stored in the main body directly spread a gap between the piston and the valve body without passing through a housing while maintaining a high flow rate when the main body of the tube container is pressed, so that the contents may be suddenly popped out of the valve hole, which disables a smooth discharge operation and causes an inconvenience in use.

In addition, according to the relate art, after the main body of the tube container is pressed to discharge the contents through the valve hole, when a hand is removed from the main body to use the discharged contents, the discharged contents may be introduced back into the main body through the discharge port, so that contamination or deterioration of the entire contents inside the main body may be caused.

Therefore, there is a need to develop a tube-type liquid discharging container that enables a smooth discharge operation, stable sealing, and hygienic use.

### DOCUMENTS OF RELATED ART

### Patent Documents

Korean Utility Model Registration No. 20-0400310 (published on Nov. 3, 2005)

### DISCLOSURE

### Technical Problem

To solve the problems described above, an object of one aspect of the present disclosure is to provide a tube-type liquid discharging container in which a flow channel for contents is ensured through a double housing structure including an inner housing and an outer housing surrounding the inner housing, so that the contents may pass through the flow channel between the inner housing and the outer housing to open and close a discharge port so as to be smoothly discharged to an outside by a discharge pressure.

In addition, an object of one aspect of the present disclosure is to provide a tube-type liquid discharging container in which a valve configured to selectively open and close a contents outlet is installed on an outer housing, and an opening and closing rod configured to elastically perform a reciprocating movement to open and close the discharge port is formed on an inner housing, so that such a double opening and closing structure may maintain stable sealing inside a tube body and enable hygienic use.

### Technical Solution

To achieve the objects described above, according to one aspect of the present disclosure, there is provided a tube-type liquid discharging container including: a tube body configured to store contents in the tube body, and having an inlet part; a shoulder coupled to the inlet part of the tube body, and having a discharge port; an inner housing formed on an inner side of the shoulder, and having a contents inlet hole formed on one side of the inner housing; an opening and closing rod formed on the inner housing to open and close the discharge port through a reciprocating movement; an elastic member configured to elastically support the opening and closing rod; an outer housing coupled to the inner housing while surrounding an outer side of the inner housing, and having a contents outlet; and a valve installed at the contents outlet of the outer housing to open and close the contents outlet, wherein the inner housing and the outer housing are spaced apart from each other by a predetermined distance, and a flow channel for the contents is formed between the inner housing and the outer housing.

In addition, a sealing member may be formed on an inner side of the tube body to maintain airtightness inside the tube body, and the sealing member may be perforated by the outer housing.

In addition, a first one-way rotation protrusion may be formed on the tube body, and a second one-way rotation protrusion may be formed on the shoulder, so that a rotation direction of the shoulder with respect to the tube body may be restricted.

In addition, a shoulder lid configured to cover at least a portion of the shoulder to protect the portion of the shoulder from an outside may be further coupled to the shoulder.

In addition, a shoulder cap may be further coupled to an outer side of the shoulder, and the shoulder cap may be formed of a metal material.

In addition, a stopper configured to restrict a downward movement of the shoulder may be removably coupled to the shoulder.

In addition, a seating sill may protrude from the outer side of the inner housing so as to be seated on an upper end of the outer housing, so that an outer periphery of the inner housing and an inner periphery of the outer housing may be spaced apart from each other.

In addition, the inner housing and the outer housing may be inserted into the tube body by a predetermined region as the shoulder moves when the tube body and the shoulder are coupled to each other.

In addition, a perforation part having a diagonal section may be formed in a lower portion of the outer housing.

In addition, the flow channel may be connected to the contents inlet hole of the inner housing and the contents outlet of the outer housing.

In addition, the flow channel for the contents may be ensured through a double housing structure including the inner housing and the outer housing surrounding the inner housing.

In addition, the discharge port of the shoulder and the contents outlet of the outer housing may be opened and closed by the opening and closing rod and the valve, respectively, so that a double opening and closing structure may be formed on front and rear sides of the flow channel.

### Advantageous Effects

According to an embodiment of the present disclosure, a flow channel for contents is ensured through a double housing structure including an inner housing and an outer housing surrounding the inner housing, so that the contents can pass through the flow channel between the inner housing and the outer housing to open and close a discharge port so as to be smoothly discharged to an outside by a discharge pressure.

According to an embodiment of the present disclosure, a valve configured to selectively open and close a contents outlet is installed on an outer housing, and an opening and closing rod configured to elastically perform a reciprocating movement to open and close the discharge port is formed on an inner housing, so that such a double opening and closing structure can maintain stable sealing inside a tube body and enable hygienic use.

### DESCRIPTION OF DRAWINGS

FIG. 1 is a perspective view showing a liquid discharging container according to an embodiment of the present disclosure.

FIG. 2 is an exploded perspective view showing the liquid discharging container according to the embodiment of the present disclosure.

FIG. 3 is a sectional view showing the liquid discharging container according to the embodiment of the present disclosure.

FIG. 4 is a sectional view illustrating a state in which a stopper is removed from a shoulder according to the embodiment of the present disclosure.

FIG. 5 is a sectional view illustrating a state in which the shoulder is rotated and coupled to a tube body according to the embodiment of the present disclosure.

FIG. 6 is a sectional view illustrating a state in which a sealing member is perforated as an outer housing is moved downward according to the embodiment of the present disclosure.

FIG. 7 is a sectional view illustrating a state in which contents are discharged by pressing the tube body according to the embodiment of the present disclosure.

FIG. 8 is a sectional view illustrating a state in which the pressing of the tube body is released according to the embodiment of the present disclosure.

### BEST MODE

The following detailed descriptions of the present disclosure are given for embodiments in which the present disclosure may be practiced, and refer to the accompanying drawings that illustrate the embodiments. These embodiments are described in sufficient detail to enable those skilled in the art to practice the present disclosure. It is to be understood that various embodiments of the present disclosure are different from each other, but need not be mutually exclusive. For example, specific shapes, structures, and characteristics described herein may be implemented and changed from one embodiment to another embodiment without departing from the idea and scope of the present disclosure. In addition, it is to be understood that positions or arrangements of individual elements in each embodiment described herein may be changed without departing from the idea and scope of the present disclosure.

Therefore, the following detailed description is not to be taken in a limiting sense, and the scope of the present disclosure is defined only by the appended claims while encompassing the scope of all equivalents of the claimed disclosure when appropriately described. In the drawings, like reference numerals refer to elements that perform the same or similar functions across various aspects.

Regarding the terms used herein, general terms that are currently used as widely as possible are selected in consideration of functions thereof in the present disclosure. However, the terms may vary according to the intention of those skilled in the art, judicial precedents, the emergence of new technologies, and the like. In addition, in certain cases, a term may be selected at discretion of the applicant. In this case, the meaning of the term will be described in detail at a corresponding part in the description of the invention. Therefore, the terms used herein are to be defined based on the meanings of the terms and the overall contents of the present disclosure without being simply limited to names of the terms.

In the present disclosure, when some part “includes” some elements, unless explicitly described to the contrary, it means that other elements may be further included but not excluded.

Hereinafter, a tube-type liquid discharging container according to an embodiment of the present disclosure will be described in detail with reference to the accompanying drawings.

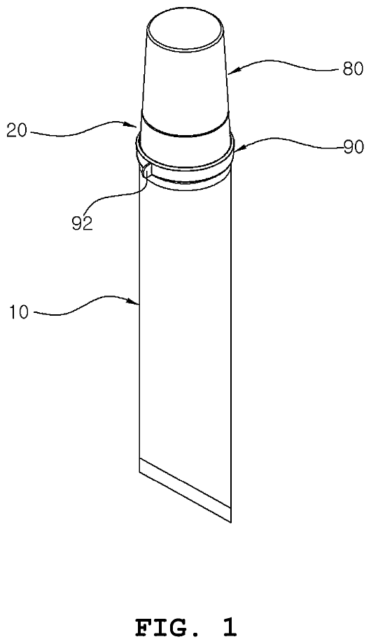

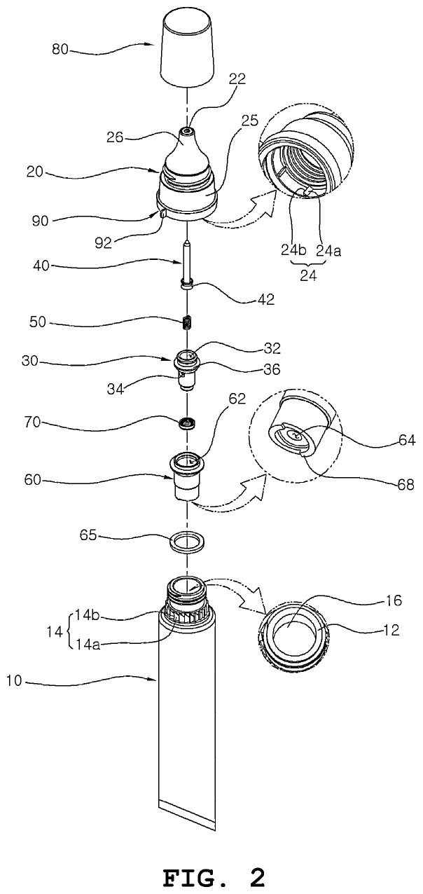

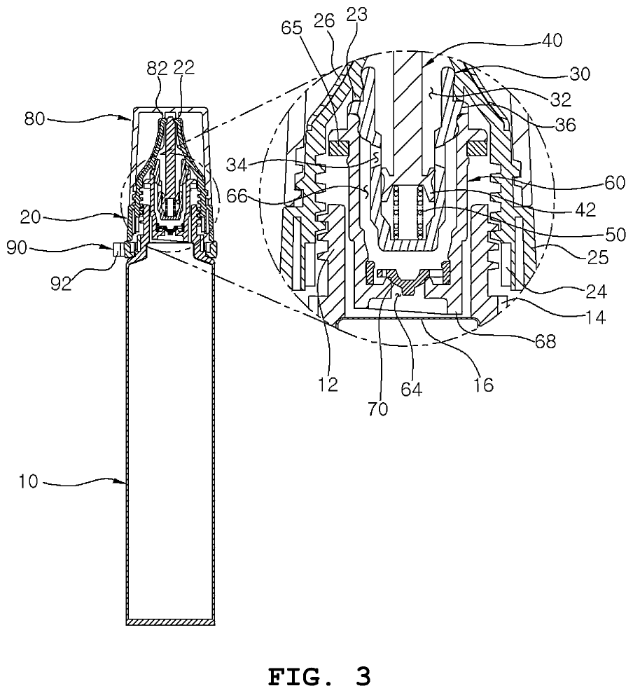

FIG. 1 is a perspective view showing a liquid discharging container according to an embodiment of the present disclosure, FIG. 2 is an exploded perspective view showing the liquid discharging container according to the embodiment of the present disclosure, and FIG. 3 is a sectional view showing the liquid discharging container according to the embodiment of the present disclosure.

As shown in the drawings, the tube-type liquid discharging container according to the embodiment of the present disclosure may include a tube body 10, a shoulder 20, an inner housing 30, an opening and closing rod 40, an elastic member 50, an outer housing 60, and a valve 70.

The tube-type liquid discharging container according to the embodiment of the present disclosure will be described separately for each component as follows.

A storage space having a predetermined size may be formed inside the tube body 10, and liquid or gel contents may be accommodated in the storage space. The tube body 10 may be a tube-type storage body having a shape that is deformed as a user presses the tube body 10 so that the contents accommodated in the tube body 10 may be discharged to an outside. The tube body 10 may be formed of a soft material so that the shape of the tube body 10 may be easily deformed by the pressing of the user, and formed of a synthetic resin material having a thin thickness, especially a polyethylene (PE) material. As shown in FIG. 1, the tube body 10 may have a streamlined shape having a width that gradually narrows from a top to a bottom, and may preferably have a lower portion that is sealed and an upper portion that is opened. However, the shape and the material of the tube body 10 are not limited as described above, and the tube body 10 may be formed in various shapes or materials in consideration of a type of the contents stored in the tube body 10, usability, design factors, or the like.

As shown in FIG. 2, an inlet part 12 may be formed on an upper portion of the tube body 10, that is, on an opposite side of the sealed portion, to discharge the contents stored in the tube body 10, and a screw thread may be formed on an outer periphery of the inlet part 12 so as to be screw-coupled to the shoulder 20. In this case, deformation degrees of the inlet part 12 and the remaining portion may become different from each other through relative thickness differences. In other words, the inlet part 12 may be formed relatively thick so that the inlet part 12 may maintain a shape of the inlet part 12 without being easily deformed by an external force, and the remaining portion may be formed relatively thin so that the remaining portion may be easily deformed by the external force of the user.

Meanwhile, a first one-way protrusion 14 may be formed on the outer periphery of the inlet part 12 of the tube body 10. The first one-way protrusion 14 may be a component configured to restrict a rotation direction of the shoulder 20 with respect to the tube body 10, the first one-way protrusion 14 may include a first inclined surface 14a formed on the outer periphery of the inlet part 12 so as to be inclined in one direction and a first restriction sill 14b protruding perpendicularly from the outer periphery of the inlet part 12, and first one-way protrusions 14 may be formed consecutively along a circumference of the inlet part 12.

As shown in FIG. 3, a sealing member 16 may be formed on an inner side of the tube body 10. The sealing member 16 may be formed adjacent to the inlet part 12 to block oxygen or light from being introduced into the tube body 10, and the sealing member 16 may be perforated by the outer housing 60 upon use of a tube container. The sealing member 16 may have one side that is closed and an opposite side that is opened so as to cover and block an inner side of the inlet part 12 of the tube body 10. In other words, the sealing member 16 may have a cylindrical hat shape having a diameter that gradually increases from the closed portion to the opened portion and having a center that rises upward, and while the closed portion of the sealing member 16 is inserted toward the inlet part 12 of the tube body 10, an edge portion of the sealing member 16 may make close contact with an inner periphery of the tube body 10, so that airtightness of the inside of the tube body 10 may be maintained. In this case, the sealing member 16 may be preferably formed of a thin metal material such as aluminium.

Meanwhile, the sealing member 16 may be attached to the inner side of the tube body 10 in an insert injection or double injection scheme, or may be attached in a heat sealing scheme by melting the inner periphery adjacent to the inlet part 12. In other words, after the sealing member 16 formed of the metal material is inserted into a molding space of a mold of the tube body 10, a molten synthetic resin may be injected into the mold space to attach the tube body 10 to the sealing member 16. In addition, an adhesive layer coated with an adhesive may be formed on a surface of the sealing member 16 to react with an injection temperature during injection molding of the tube body 10, or an etching scheme (using chemicals to corrode a surface of a metal, ceramic, a semiconductor, or the like) may be applied to the surface of the sealing member 16, so that the sealing member 16 formed of the metal material and the tube body 10 formed of the synthetic resin material may be easily attached to each other.

The shoulder 20 may be coupled to the inlet part 12 of the tube body 10, and may have a discharge port 22 formed on one side of the shoulder 20 to discharge the contents stored in the tube body 10 to the outside. The shoulder 20 may preferably have a shape having an outer diameter that gradually decreases toward an end so as to have a sharp end in consideration of usability and design factors.

The shoulder 20 may be a discharge cap coupled to the inlet part 12 of the tube body 10 while surrounding the inlet part 12 of the tube body 10, and configured to discharge the contents stored in the tube body 10 to the outside, and the inner housing 30 and the outer housing 60 may be formed in an inner space of the shoulder 20. A coupling extension protrusion wheel 23 may be formed on an inner side of the shoulder 20 to extend downward, and fixedly coupled to an upper outer periphery of the inner housing 30 while surrounding the upper outer periphery of the inner housing 30, and a screw thread may be formed on an inner periphery of the shoulder 20 so as to be screw-coupled to the screw thread formed on the outer periphery of the inlet part 12 of the tube body 10.

As shown in FIG. 2, a second one-way protrusion 24 may be formed on the inner periphery of the shoulder 20 to protrude inward so as to restrict the rotation direction of the shoulder 20 with respect to the tube body 10 together with the first one-way protrusion 14 formed on the tube body 10. Similar to the first one-way protrusion 14 described above, the second one-way protrusion 24 may include a second inclined surface 24a formed on the inner periphery of the shoulder 20 so as to be inclined in one direction and a second restriction sill 24b protruding perpendicularly from an outer periphery of the shoulder 20, and second one-way protrusions 24 may be formed consecutively along a circumference of the inner periphery of the shoulder 20. In other words, when the shoulder 20 is rotated in one direction, the shoulder 20 may rotate as the first inclined surface 14a of the first one-way protrusion 14 rides over the second inclined surface 24a of the second one-way protrusion 24. However, when the shoulder 20 is rotated in an opposite direction, the first restriction sill 14b of the first one-way protrusion 14 may be caught by the second restriction sill 24b of the second one-way protrusion 24, so that the shoulder 20 may not be rotated. Therefore, once the shoulder 20 is screw-coupled to the tube body 10 as the shoulder 20 is rotated in one direction, the shoulder 20 may not be rotated in the opposite direction due to the first one-way protrusion 14 and the second one-way protrusion 24, so that the tube body 10 and the shoulder 20 may not be released from each other.

As shown in FIG. 3, a lower extension protrusion wheel 25 may extend downward while being spaced apart from the outer periphery of the shoulder 20 by a predetermined distance. In this case, the lower extension protrusion wheel 25 may preferably extend further than a lower end of the shoulder 20, and have the same diameter as the tube body 10 for design continuity.

A shoulder lid 80 configured to cover at least a portion of the shoulder 20 to protect the portion of the shoulder 20 from the outside may be further coupled to the shoulder 20. A screw thread may be formed on an inner periphery of the shoulder lid 80 so as to be screw-coupled to the screw thread formed on the outer periphery of the shoulder 20, and an end of the shoulder lid 80 may be seated on an upper end of the lower extension protrusion wheel 25 of the shoulder 20. An airtight ring 82 may be formed on an inner side of the shoulder lid 80, and the airtight ring 82 may protrude in a ring shape to make close contact with an outer end of the discharge port 22 of the shoulder 20, so that when the shoulder 20 and the shoulder lid 80 are fastened to each other, airtightness of the discharge port 22 of the shoulder 20 may be more stably maintained by the airtight ring 82. Although the shoulder 20 and the shoulder lid 80 have been shown in the drawings of the liquid discharging container according to the embodiment of the present disclosure as being screw-coupled to each other, embodiments are not limited thereto, and various types of coupling structures, such as undercut coupling, coupling of protrusions and grooves, or coupling by a magnetic force may be provided.

Meanwhile, a stopper 90 configured to restrict a downward movement of the shoulder 20 may be removably coupled to an outer lower end of the shoulder 20. The stopper 90 may have a shape of a strip that surrounds an outer side of the inlet part 12 of the tube body 10, and may be formed between the tube body 10 and the shoulder 20 to prevent the shoulder 20 from moving downward against intention of the user during distribution or storage. In this case, the stopper 90 may be detachably attached to the lower end of the shoulder 20, and may be formed of a soft material so that the user may easily tear the stopper 90 off from the shoulder 20. A handle 92 may be preferably formed on one side of the stopper 90 to protrude outward so that the user may easily pull and tear off the stopper 90.

In addition, a shoulder cap 26 may be further coupled to an outer side of the shoulder 20. In this case, the shoulder cap 26 may be preferably coupled to at least a portion of the shoulder 20 while surrounding the portion of the shoulder 20, and formed of a thin metal material such as aluminium for visual effects or cooling sensations.

The inner housing 30 may be fixedly coupled to the inner space of the shoulder 20. In other words, an upper portion of the inner housing 30 may be fitted into the coupling extension protrusion wheel 23 of the shoulder 20 so as to be undercut-coupled or forcibly fitted.

The inner housing 30 may serve as a temporary storage space for the contents, the inner housing 30 may have a cylindrical shape having one side that is opened and an opposite side that is closed, a predetermined installation space 32 may be formed on an inner side of the inner housing 30, and the elastic member 50 and the opening and closing rod 40 may be installed in the installation space 32 in a discharge direction of the contents. In other words, the elastic member 50 may be inserted into the opened portion of the inner housing 30, and at least a portion of the opening and closing rod 40 may be inserted into the opened portion of the inner housing 30 so as to be seated on an end of the elastic member 50, so that the opening and closing rod 40 may elastically perform a reciprocating movement in a predetermined region in a longitudinal direction of the inner housing 30.

As shown in the partially enlarged view of FIG. 3, a contents inlet hole 34 configured to allow the contents stored in the tube body 10 to be introduced into an inner space of the inner housing 30 may be formed on one side of the inner housing 30. In this case, a pair of contents inlet holes 34 may be preferably formed on the outer side of the inner housing 30 to ensure smooth introduction of the contents.

Meanwhile, a seating sill 36 may protrude from the outer side of the inner housing 30, and the seating sill 36 may be seated on an upper end of the outer housing 60 to restrict an insertion region of the inner housing 30 into the outer housing 60. In other words, the inner housing 30 may not be completely inserted into the outer housing 60 due to the seating sill 36, and the outer housing 60 and the inner housing 30 may be spaced apart from each other by a predetermined distance, so that the contents may move through a gap between the outer housing 60 and the inner housing 30.

The opening and closing rod 40 may be installed in the installation space 32 of the inner housing 30, and may perform a reciprocating movement by a discharge pressure of the contents to temporarily open and close the discharge port 22 of the shoulder 20. In this case, the opening and closing rod 40 may preferably have a cylindrical shape having a long length and a small width (diameter).

The opening and closing rod 40 may have one end inserted into or removed from the discharge port 22 to open and close the discharge port 22, an opening and closing rod blade 42 may be formed on an outer periphery of the opening and closing rod 40 to make close contact with an inner periphery of the inner housing 30, and the elastic member 50 may be inserted into the opening and closing rod blade 42. In this case, it would be appropriate for the opening and closing rod blade 42 to perform a reciprocating movement between a bottom surface of the inner housing 30 and the contents inlet hole 34 by a distance at which the opening and closing rod blade 42 is pushed and moved by the discharge pressure of the contents.

The elastic member 50 may be installed in the installation space 32 of the inner housing 30 to elastically support the opening and closing rod 40. In this case, the elastic member 50 may be preferably a compression spring (a spring that resists against a compressing force) formed of a metal material such as SUS-304.

The elastic member 50 may have one end making close contact with an inner bottom surface of the inner housing 30 and an opposite end making close contact with an end of the opening and closing rod 40, and may provide elasticity to the opening and closing rod 40.

The outer housing 60 may be fixedly coupled to at least a portion of the inner housing 30 while surrounding the portion of the inner housing 30 from outer side of the inner housing 30. Although the inner housing 30 and the outer housing 60 have been shown in the drawings of the liquid discharging container according to the embodiment of the present disclosure as being undercut-coupled to each other, embodiments are not limited thereto, and various coupling structures that allow the outer housing 60 to be stably and fixedly coupled to the outer side of the inner housing 30 may be provided.

The outer housing 60 may serve as a temporary storage space for the contents together with the inner housing 30, a contents outlet 64 through which the contents stored in the tube body 10 passes may be formed on a bottom surface of the outer housing 60, and a valve 70 configured to selectively open and close the contents outlet 64 may be installed at the contents outlet 64.

An insertion space 62 into which the inner housing 30 is inserted may be formed on an inner side of the outer housing 60. In this case, an inner periphery of the outer housing 60 and the outer periphery of the inner housing 30 may be spaced apart from each other by a predetermined distance, and a flow channel 66 for the contents may be formed between the inner periphery of the outer housing 60 and the outer periphery of the inner housing 30. In other words, as shown in the partially enlarged view of FIG. 3, when the inner housing 30 is inserted and coupled into the outer housing 60, a predetermined space may be formed between an outer circumference of the inner housing 30 and an inner circumference of the outer housing 60, and the formed space may become the flow channel 66 for stably moving the contents. In this case, the flow channel 66 may be connected to the contents inlet hole 34 of the inner housing 30 and the contents outlet 64 of the outer housing 60.

Meanwhile, a perforation part 68 having a diagonal section may be formed in a lower portion of the outer housing 60, that is, on an opposite side of the opened portion. The perforation part 68 may be a part for perforating the sealing member 16 formed in the tube body 10, and a pair of perforation parts 68 may be preferably formed and arranged symmetrically to each other as shown in FIG. 2. In other words, in order to use the liquid discharging container according to the present disclosure, when the stopper 90 is removed from the shoulder 20, and the shoulder 20 from which the stopper 90 is removed is coupled to the tube body 10, the inner housing 30 and the outer housing 60 may be inserted into the tube body 10 by a predetermined region as the shoulder 20 moves, so that the perforation part 68 of the outer housing 60 may pass through and perforate the sealing member 16 to open the inlet part 12 of the tube body 10.

In this case, the inner housing 30, the opening and closing rod 40, and the outer housing 60 may be formed of a thermosetting resin or a thermoplastic resin, the thermosetting resin may preferably include at least one material among an epoxy resin, an amino resin, a phenol resin, and a polyester resin, the thermoplastic resin may preferably include at least one material among polyethylene, an acrylic resin, polypropylene, polystyrene, polyvinyl chloride, Teflon, nylon, and a polyacetal resin, and particularly, the thermoplastic resin may most preferably include a polypropylene material. However, the inner housing 30, the opening and closing rod 40, and the outer housing 60 are not limited to the materials described above, and may be formed of various other materials.

Meanwhile, a gasket 65 may be formed between the outer housing 60 and the tube body 10 to seal the inside of the tube body 10. The gasket 65 may have a ring shape so as to be fitted around an outer side of the outer housing 60. In this case, the gasket 65 may be formed of an elastic material to maintain airtightness between the outer housing 60 and the tube body 10, the gasket 65 may be preferably formed of at least one material among urethane rubber, natural rubber, elastomer, nitrile-butadiene rubber (NBR), and silicone, polypropylene, or acrylonitrile butadiene styrene (ABS), and particularly, the gasket 65 may be most preferably formed of a polyethylene material having elasticity.

The valve 70 may be installed at the contents outlet 64 of the outer housing 60 to open and close the contents outlet 64. In this case, the valve 70 may be preferably a disc valve having a disc shape and lifted upward by an internal pressure of the tube body 10 and restored to selectively open and close the contents outlet 64.

As described above, according to the tube-type liquid discharging container of the embodiment of the present disclosure, the flow channel 66 for the contents may be ensured through a double housing structure including the inner housing 30 and the outer housing 60 surrounding the inner housing 30, and a double opening and closing structure of the outer housing 60 and the discharge port 22 may be formed, so that the contents may pass through the flow channel 66 to open and close the discharge port 22 so as to be smoothly discharged to the outside by the discharge pressure, contamination of the contents stored in the tube body 10 may be prevented, and hygienic use of the tube container may be enabled.

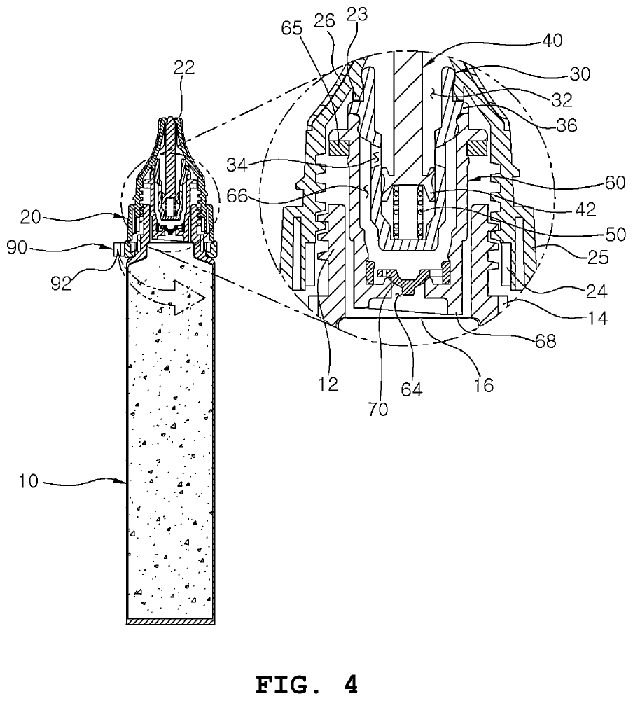

FIGS. 4 to 8 are views illustrating use of the tube-type liquid discharging container according to the embodiment of the present disclosure, and a method for using the tube-type liquid discharging container according to the embodiment of the present disclosure will be described with reference to FIGS. 4 to 8.

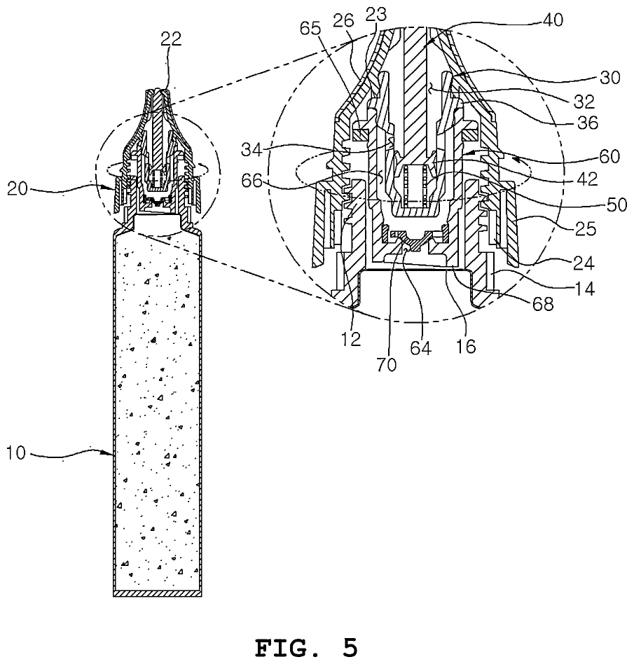

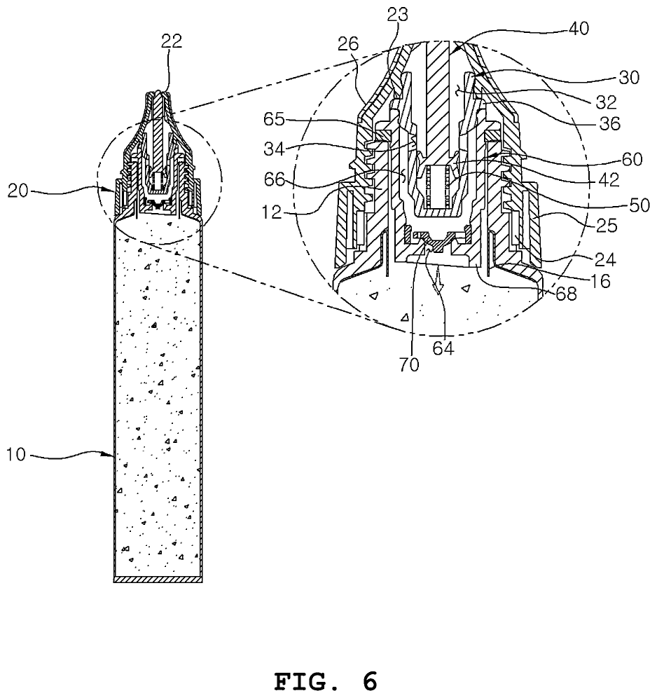

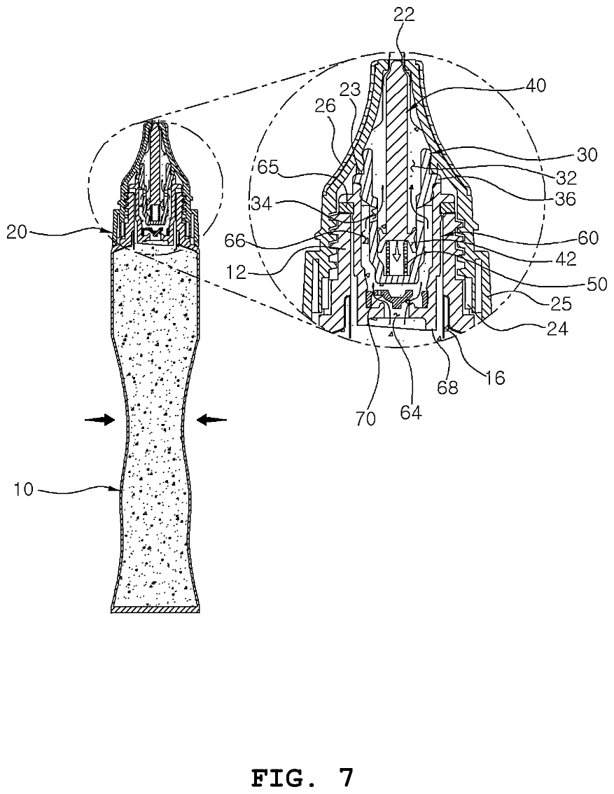

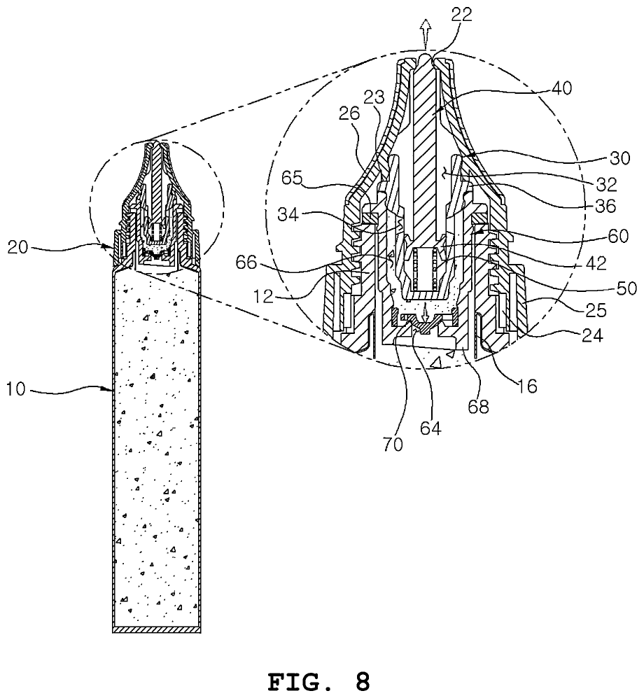

FIG. 4 is a sectional view illustrating a state in which a stopper is removed from a shoulder according to the embodiment of the present disclosure, FIG. 5 is a sectional view illustrating a state in which the shoulder is rotated and coupled to a tube body according to the embodiment of the present disclosure, FIG. 6 is a sectional view illustrating a state in which a sealing is perforated as an outer housing is moved downward according to the embodiment of the present disclosure, FIG. 7 is a sectional view illustrating a state in which contents are discharged by pressing the tube body according to the embodiment of the present disclosure, and FIG. 8 is a sectional view illustrating a state in which the pressing of the tube body is released according to the embodiment of the present disclosure.

First, as shown in FIG. 4, the shoulder lid 80 may be separated from the shoulder 20, and the stopper 90 attached to an end of the shoulder 20 may be pulled and torn off from the shoulder 20. In this case, the shoulder 20 and the tube body 10 may be spaced apart from each other by a height of the removed stopper 90.

Next, as shown in FIG. 5, when the shoulder 20 is rotated from the tube body 10 in one direction, the tube body 10 and the shoulder 20 may be coupled to each other so that the shoulder 20 may gradually move toward the tube body 10, and simultaneously, the inner housing 30 and the outer housing 60 coupled to the inner side of the shoulder 20 may be gradually inserted into the inlet part 12 of the tube body 10.

As shown in FIG. 6, when the shoulder 20 is continuously rotated from the tube body 10, the perforation part 68 of the outer housing 60 may pass through the sealing member 16 formed on the inner side of the tube body 10 to open the inlet part 12 of the tube body 10. In this case, the contents outlet 64 of the outer housing 60 may be closed by the valve 70, the discharge port 22 of the shoulder 20 may be closed by the opening and closing rod 40, and airtightness of a gap between the tube body 10 and the outer housing 60 may be maintained by the gasket 65.

Next, as shown in FIG. 7, when a side surface of the tube body 10 is pressed, a pressure may be generated inside the tube body 10, and the contents accommodated in the tube body 10 may be discharged through the discharge port 22 of the shoulder 20 by the discharge pressure. In more detail, the valve 70 may be pushed upward by the discharge pressure of the contents so that the contents outlet 64 of the outer housing 60 may be opened, and the contents that have passed through the contents outlet 64 may pass through the flow channel 66 between the inner housing 30 and the outer housing 60 so as to be introduced into the inner space of the inner housing 30 through the contents inlet hole 34 of the inner housing 30. Sequentially, the opening and closing rod 40 may be pushed rearward by the discharge pressure of the contents so that the end of the opening and closing rod 40 and the discharge port 22 of the shoulder 20 may be spaced apart from each other to open the discharge port 22, and simultaneously, the contents may be discharged to the outside through the discharge port 22.

Next, as shown in FIG. 8, when the pressing of the side surface of the tube body 10 is released, the discharge pressure may be released so that the opening and closing rod 40 may be restored to an original form of the opening and closing rod 40 by an elastic restoring force of the elastic member 50 so as to close the discharge port 22 of the shoulder 20, and simultaneously, the valve 70 may be restored to an original form of the valve 70 so as to close the contents outlet 64 of the outer housing 60.

After the use, the shoulder 20 may be covered with and coupled to the shoulder lid 80 for storage or carrying.

Although the above description has been made with reference to illustrative embodiments and drawings as well as certain matters such as specific elements, the embodiments are provided for an overall understanding of the present disclosure, so the present disclosure is not limited to the embodiments. It will be understood by a person having ordinary skill in the art to which the present disclosure pertains that various changes and modifications can be made from the above description. Therefore, the idea of the present disclosure shall not be construed as being limited to the embodiments described herein, and it will be understood that the scope of the idea of the present disclosure encompasses the scope of the appended claims and all variations equivalent thereto.

### DESCRIPTION OF REFERENCE NUMERALS

10: Tube body 12: Inlet part
14: First one-way protrusion 16: Sealing member
20: Shoulder 22: Discharge port
23: Coupling extension protrusion wheel 24: Second one-way
protrusion
25: Lower extension protrusion wheel 30: Inner housing
32: Installation space 34: Contents inlet hole
40: Opening and closing rod 50: Elastic member
60: Outer housing 62: Insertion space
64: Contents outlet 66: Flow channel
68: Perforation part 70: Valve
80: Shoulder lid 90: Stopper

1. A tube-type liquid discharging container comprising:
a tube body configured to store contents in the tube body, and having an inlet part;
a shoulder coupled to the inlet part of the tube body, and having a discharge port;
an inner housing formed on an inner side of the shoulder, and having a contents inlet hole formed on one side of the inner housing;
an opening and closing rod formed on the inner housing to open and close the discharge port through a reciprocating movement;
an elastic member configured to elastically support the opening and closing rod;
an outer housing coupled to the inner housing while surrounding an outer side of the inner housing, and having a contents outlet; and
a valve installed at the contents outlet of the outer housing to open and close the contents outlet,
wherein the inner housing and the outer housing are spaced apart from each other by a predetermined distance, and a flow channel for the contents is formed between the inner housing and the outer housing.

2. The tube-type liquid discharging container of claim 1, wherein a sealing member is formed on an inner side of the tube body to maintain airtightness inside the tube body, and the sealing member is perforated by the outer housing.

3. The tube-type liquid discharging container of claim 1, wherein a first one-way rotation protrusion is formed on the tube body, and a second one-way rotation protrusion is formed on the shoulder, so that a rotation direction of the shoulder with respect to the tube body is restricted.

4. The tube-type liquid discharging container of claim 1, wherein a shoulder lid configured to cover at least a portion of the shoulder to protect the portion of the shoulder from an outside is further coupled to the shoulder.

5. The tube-type liquid discharging container of claim 1, wherein a shoulder cap is further coupled to an outer side of the shoulder, and the shoulder cap is formed of a metal material.

6. The tube-type liquid discharging container of claim 1, wherein a stopper configured to restrict a downward movement of the shoulder is removably coupled to the shoulder.

7. The tube-type liquid discharging container of claim 1, wherein a seating sill protrudes from the outer side of the inner housing so as to be seated on an upper end of the outer housing, so that an outer periphery of the inner housing and an inner periphery of the outer housing are spaced apart from each other.

8. The tube-type liquid discharging container of claim 1, wherein the inner housing and the outer housing are inserted into the tube body by a predetermined region as the shoulder moves when the tube body and the shoulder are coupled to each other.

9. The tube-type liquid discharging container of claim 1, wherein a perforation part having a diagonal section is formed in a lower portion of the outer housing.

10. The tube-type liquid discharging container of claim 1, wherein the flow channel is connected to the contents inlet hole of the inner housing and the contents outlet of the outer housing.

11. The tube-type liquid discharging container of claim 1, wherein the flow channel for the contents is ensured through a double housing structure including the inner housing and the outer housing surrounding the inner housing.

12. The tube-type liquid discharging container of claim 1, wherein the discharge port of the shoulder and the contents outlet of the outer housing are opened and closed by the opening and closing rod and the valve, respectively, so that a double opening and closing structure is formed on front and rear sides of the flow channel.
